(19) United States
(12) Patent Application Publication
(10) Pub. No.: US 2025/0198439 A1
(43) Pub. Date: Jun. 19, 2025

(54) DEVICE FOR COMPENSATING FOR TOLERANCES BETWEEN TWO COMPONENTS TO BE CONNECTED TO ONE ANOTHER

(71) Applicant: Witte Automotive GmbH, Velbert (DE)

(72) Inventors: Jan Christian BENTE, Sprockhövel (DE); Harry PURWIN, Ratingen (DE); Aykut CÖPÜR, Wuppertal (DE)

(21) Appl. No.: 18/976,415

(22) Filed: Dec. 11, 2024

(30) Foreign Application Priority Data
Dec. 18, 2023 (DE) 10 2023 212 880.2

(51) Int. Cl. F16B 5/02

(52) U.S. Cl. CPC F16B 5/025; F16B 5/0233

(57) ABSTRACT

A device for compensating for tolerances between two components to be connected to one another may have one base element having a cavity having an internal thread, and a compensation element having an external thread, which is or can be brought into threaded engagement with the base element and can be moved from a starting position into a compensating position by being rotated relative to the base element. At least the external thread of the compensation element has a cross section which differs in shape from a circular cross section and is in frictional engagement with the internal thread of the base element in the compensating position in order to tighten a screw member.

### FIELD

The invention relates to a device for compensating for tolerances between two components to be connected to one another, for example body components and/or interior components of a vehicle.

### BACKGROUND

Such a device is known in principle and is used, for example, in vehicle construction, in particular when screwing two components together over a joint gap and/or a joint spacing which is subject to tolerances.

Tolerance compensation devices are generally known and belong to fastening elements for fastening components and parts to one another—in particular in motor vehicles. For example, tolerance compensation devices or tolerance compensation elements are known that are used in vehicle construction, in particular when screwing together two components across a joint gap subjected to tolerance. For this purpose, the tolerance compensation device is arranged between the components to be connected, and a screw member for screwing the components together, for example a screw or stud bolt, is passed through correspondingly provided openings in the components and through the tolerance compensation device. When screwing the screw member, the compensation element is rotated relative to the base element by means of a driving spring located between the screw member and the compensation element and is thus moved axially to the base element from its starting position, for example it is moved out of the base element until it reaches its compensating position, in which the base element and the compensation element each lie against one of the components and thus bridge the joint gap.

The object of the present invention is to specify an improved device, in particular a tolerance compensation device, in comparison with the prior art.

According to the invention, the object is achieved by the features stated in claim 1.

### SUMMARY

The device according to the invention for compensating for tolerances between two components to be connected to one another comprises at least one base element having a cavity having an internal thread, and a compensation element having an external thread, which is or can be brought into threaded engagement with the base element and can be moved from a starting position into a compensating position by being rotated relative to the base element, wherein at least the external thread of the compensation element has a cross section that differs in shape from a circular cross section and is in frictional engagement with the internal thread of the base element in the compensating position in order to tighten a screw member.

Since at least the external thread of the compensation element has a cross section that differs in shape from a circular cross section and is in frictional engagement with the internal thread of the base element in the compensating position in order to tighten a screw member, the compensation element can be moved into a corresponding compensating position before the two components to be connected are fixed, in order to subsequently enable a screw member to be tightened. Due to the different cross section, for example a non-round cross section or a non-circular cross section, of the external thread, the compensation element can be easily connected to the base element, in particular wedged and/or clamped in the base element. The different cross section, in particular a cross section differing from a round or circular cross section, can in particular reinforce the need for thread engagement in order to absorb a torque to be applied to the screw member when it is screwed in.

Furthermore, the advantages achieved with the invention consist in that simple assembly of the device and simple subsequent fixing of the two components to be connected can be achieved. The different shape, in particular a non-round or non-circular shape, of the external thread allows for torque control. In addition, zero play can be ensured between the device and the components.

The device can, for example, be a tolerance compensation device which can be brought to a suitable height to bridge a gap, for example a joint gap, between the components to be connected before the components are fixed. For example, they may concern components for assembling a rear light of a vehicle.

In other words: The base element with the compensation element arranged therein can be easily pre-assembled on one of the components, for example at a customer interface. The compensation element can be rotated relative to the base element to adjust the height of the compensation element relative to the base element. The compensation element may have a non-round contour to control torques.

The compensation element can have at least one drive contour by means of which the compensation element can be moved from the base element into the compensating position before the components to be connected are fixed. This enables axial tolerance compensation. The compensation element can be rotated relative to the base element by means of the drive contour. By rotating the compensation element on the drive contour, in particular at the drive interface, the compensation element can be moved relative to the base element, in particular out of the base element. This allows the height of the device, in particular the tolerance compensation device, to be adjusted.

The drive contour can be a drive interface. The drive contour can be an internal contour, for example an internal drive interface. The drive contour can, alternatively or optionally additionally, be an external contour, for example an external drive interface.

For example, the drive contour can be formed by a flange portion on the compensation element, wherein the flange portion can have an angular drive contour, in particular external contour, which can be gripped by a suitable tool. The drive contour, for example the external drive interface, can be designed as a hexagonal drive or a square drive. A conventional drive tool, for example in the form of a wrench, can be used.

For example, the drive contour can be formed by a recess in the flange portion, into which a suitable tool can be inserted. For example, the drive contour, for example the internal drive interface, can comprise a hexagon socket or square socket, a slot or a crossed slot. For example, rotation of the compensation element can be initiated via the drive contour. A conventional drive tool, for example in the form of a screwdriver, can be used.

The compensation element can comprise a cavity having an internal thread, wherein, after assuming the compensating position, the screw member can be tightened in order to fix the components to be connected in the cavity. The internal thread of the compensation element can have a circular cross section. The screw member can be a connecting screw.

The internal thread of the base element can have a circular cross section, wherein, in the compensating position, the compensation element is in frictional clamping engagement with the base element without play. A clamping connection, in particular frictional engagement, without play can be easily achieved by the interaction of a circular or round internal thread with a non-circular or non-round external thread.

Engagement between the base element and compensation element that has no play, or at least reduced play and/or is self-locking is understood in particular to mean form-fitting and/or force-fitting clamping, in particular wedging, of the two elements, such that they are rigidly connected to one another and are immovable, in particular are blocked against rotating relative to one another.

The external thread can have an oval, elliptical or trilobular cross section. The external thread can have at least two rounded corners in cross section.

The external thread, in particular an external contour of the compensation element, can have a cross section that differs from a circular cross section, in particular a substantially non-circular cross section. The internal thread, in particular an inner contour of the base element, can be substantially circular. The external contour can be trilobular and have three rounded corners, also called a circular triangle. Alternatively, the external contour can be oval or elliptical, in which case only two radial overhangs are formed instead of three radial overhangs. The external thread, in particular the external contour, can also be designed in such a way that four radial overhangs are formed. Such an external contour is also referred to as a rounded square.

This makes it possible to achieve clamping, in particular self-locking, frictional engagement with at least reduced play, in particular no play, when unscrewing the compensation element from the base element. By means of such a contour and mating contour, in particular such an external thread and internal thread, a particularly effective force fit and engagement can be made possible in a simple manner without additional means.

The external thread can also have a different cross sectional shape, for example a rounded bigon shape, a rounded square shape or a rounded polygon shape.

Alternatively, the external thread of the compensation element can have a circular cross section and the internal thread of the base element can have a different cross section, for example a non-circular or non-round cross section.

The base element can comprise a flange portion, at least regions of which surround an external circumference, and at least one outwardly projecting retaining lug. The retaining lug can have a support surface that extends obliquely in the circumferential direction, at least in portions. For example, the retaining lug can comprise at least one substantially straight portion and an oblique portion adjacent thereto. When the base element is assembled on one of the components, the component is or can be clampingly received between the flange portion and the retaining lug. The oblique portion can form a ramp and serve as an insertion aid when the base element is rotated relative to the component to secure or clamp the component between the flange portion and the retaining lug. The retaining lug can be reversibly flexible.

The base element and the compensation element can be pre-positioned, in particular pre-assembled, on one of the components. The base element can, for example, be pre-assembled into one of the two components to be connected using a type of bayonet lock.

The base element can comprise at least one positioning element, which can be designed to secure and/or lock the base element against rotating on the component when the base element is assembled on one of the components.

The advantages achieved by means of the invention consist in particular in the fact that a device is provided for connecting two components, which has a simple design, compensates for tolerances between the components and is particularly easy to pre-assemble and assemble. The device can be brought to a correct height, in particular by the axial displacement of the compensation element relative to the base element, before fixing the two components together by means of a connecting element, in particular a screw member.

A method according to the invention for connecting two components by means of at least one previously described device, in particular a tolerance compensation device, can comprise at least the following steps of:
Pre-assembling the base element together with the compensation element arranged therein on one of the components to be connected,
Adjusting or positioning the compensation element in a compensation position by unscrewing the compensation element from the base element out of a starting position into the compensation position,
Placing the second component on the compensation element after assuming the compensation position,
Screwing a screw member through the second component and into the compensation element and tightening the screw member on the compensation element in order to fix the two components.

### DESCRIPTION OF THE FIGURES

Exemplary embodiments of the invention are explained in greater detail with reference to the drawings. In the figures:

FIG. 1 is a schematic perspective view of a device according to the invention for compensating for tolerances between at least two components to be connected to one another, comprising at least one base element and one compensation element,

FIG. 2 schematically shows another perspective view of the device according to FIG. 1,

FIG. 3 schematically shows a sectional view of the device according to FIG. 1,

FIG. 4 schematically shows an exploded view of the device according to FIG. 1,

FIG. 5 schematically shows a perspective view of the compensation element of the device;

FIG. 6 is a schematic plan view of the device according to FIG. 1,

FIGS. 7 to 9 are schematic perspective views of a process for pre-assembling the device on one of the components to be connected,

FIGS. 10 to 12 are schematic sectional views of an assembly process for fixing the two components to be connected together,

FIG. 13 is a schematic view from below of the device in the pre-assembled state on one of the components to be connected,

FIG. 14 is a schematic sectional view of a partial view of the device in the pre-assembled state on one of the components to be connected,

FIG. 15 is a schematic perspective view of a further embodiment of a device according to the invention for compensating for tolerances between at least two components to be connected to one another, comprising at least one base element and one compensation element,

FIG. 16 schematically shows a further perspective view of the device according to FIG. 15, and

FIG. 17 is a schematic sectional view of another embodiment of a compensation element of a device for compensating for tolerances at least between two components to be connected to one another.

### DETAILED DESCRIPTION

Parts corresponding to one another are provided with the same reference signs in all the drawings.

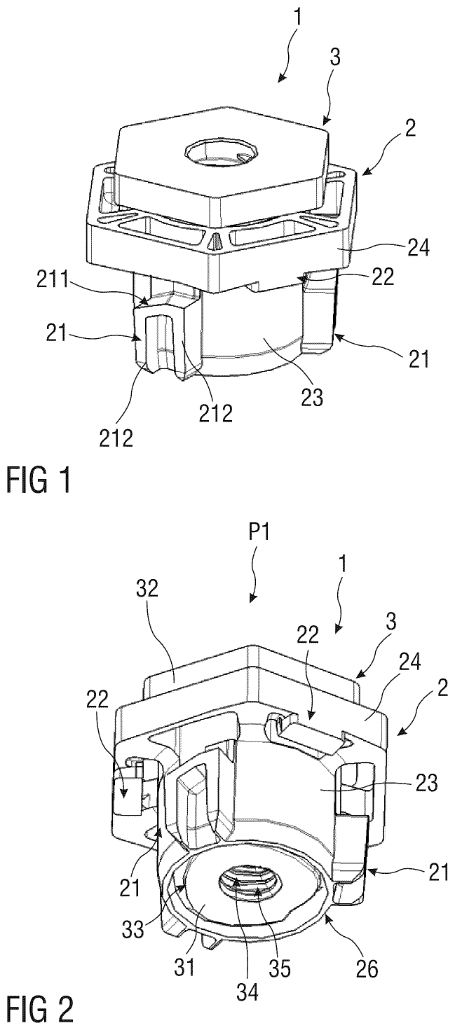

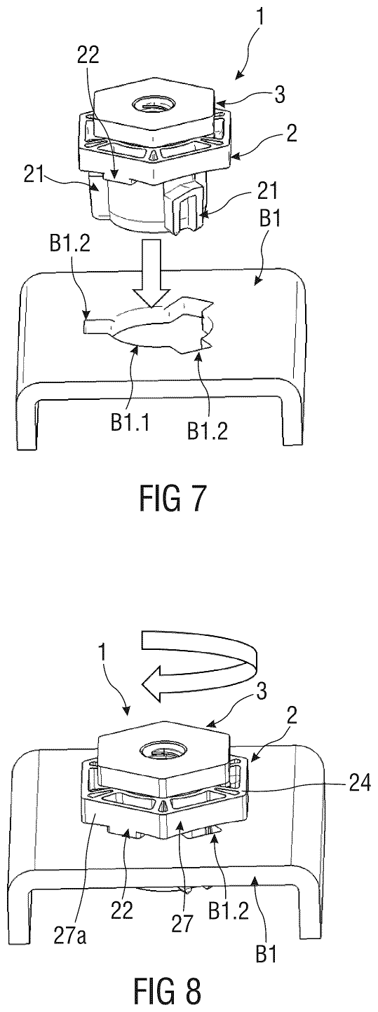

FIG. 1 is a schematic perspective view of a device 1 according to the invention for compensating for tolerances, in particular axial tolerances, between at least two components B1, B2 to be connected to one another (shown in FIGS. 7 to 14).

The device 1 is provided, for example, for attaching a first component B1, for example a bearing bracket, an electronic part, a lamp or a decorative part, to a second component B2, for example a door panel, a supporting structure or a body structure of a vehicle. For example, the device 1 can be provided for connecting components in a vehicle interior, for example consoles, armrests and other vehicle components.

The device 1 comprises at least one base element 2, for example a hollow-cylindrical base element 2. The device 1 comprises at least one compensation element 3, for example a substantially hollow-cylindrical compensation element 3.

The base element 2 is designed as a retaining element for holding the device 1 on a first component B1. For this purpose, the first component B1 has at least one cutout B1.1, for example shown in FIG. 7.

The base element 2 comprises at least one base body 23. A flange portion 24 is provided on the end face of the base body 23. The flange portion 24 can be larger in diameter than the base body 23 and form a bearing surface to be brought into contact with one of the components B1, B2.

The base element 2 comprises at least one retaining lug 21 or a plurality of retaining lugs 21, which, together with the base body 23, are to be guided through the cutout B1.1 in the component B1. Furthermore, the base element 2 comprises at least one positioning element 22 or a plurality of positioning elements 22.

In the illustrated embodiment, the base element 2 comprises three retaining lugs 21 and three positioning elements 22. A positioning element 22 is arranged between each two retaining lugs 21, or a retaining lug 21 is arranged between each two positioning elements 22.

The retaining lugs 21 are arranged rotationally symmetrically on the external circumference of the base element 2, in particular on the base body 23. The retaining lugs 21 are each spaced apart and/or offset from one another within an angular range of 120°.

The positioning elements 22 are rotationally symmetrically distributed on an underside of the flange portion 24 of the base element 2. The positioning elements 22 protrude downward from the underside of the flange portion 24. The positioning elements 22 are each spaced apart and/or offset from one another within an angular range of 120°.

The corresponding positioning element 22 is offset and/or spaced apart from the corresponding retaining lug 21, for example by 60°.

Other angles and angle ranges are conceivable and can vary depending on the number of retaining lugs 21 and/or positioning elements 22.

The retaining lugs 21 each have a support surface 211, at least portions of which extend obliquely in the circumferential direction of the base element 2 or the base body 23. The retaining lugs 21 can each have two support projections 212 spaced apart from one another and running in parallel, and one support surface 211 connecting the support projections 212. The retaining lugs 21 can be, for example, bayonet elements, for example bayonet lugs, so-called bayonet legs or bayonet arms.

The retaining lugs 21 can also have a different shape, for example a block-like shape.

When the base element 2 is assembled, for example pre-assembled, together with the compensation element 3 arranged therein on one of the components B1, B2, the component B1, B2 can be clamped between the flange portion 24, in particular the underside of the flange portion 24, and the corresponding retaining lug 21.

When the base element 2 is assembled on one of the components B1, B2, the corresponding positioning element 22 can secure the base element 2 to prevent it from rotating.

FIG. 2 schematically shows another perspective view of the device 1 according to FIG. 1.

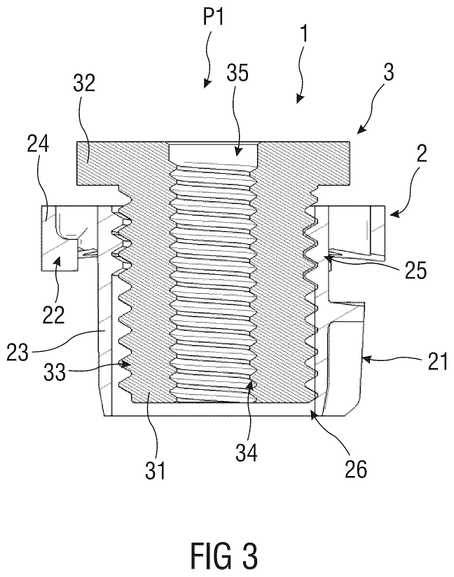

The base element 2 comprises a cavity 26 having an internal thread 25 (for example shown in FIG. 3). The internal thread 25 can, for example, extend over a portion of the cavity 26. For example, the internal thread 25 can be partially formed on an end face. For example, the internal thread 25 can be arranged in the region of the flange portion 24. In a development, the internal thread 25 can also extend continuously over an entire internal circumferential surface of the cavity 26.

The compensation element 3 comprises a base body 31 and a flange portion 32 arranged on the end face of the base body 31. The flange portion 32 can be larger in diameter than the base body 31 and form a bearing surface to be brought into contact with one of the components B1, B2.

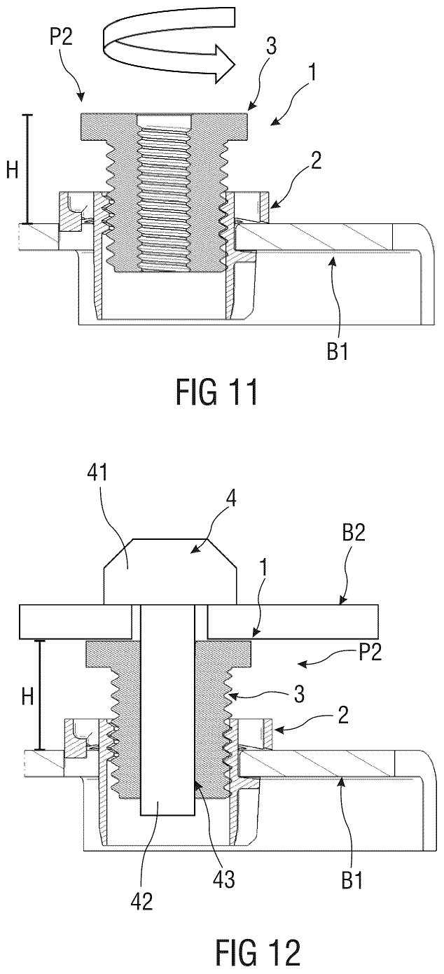

The compensation element 3, in particular its base body 31, comprises an external thread 33 and a cavity 35 having an internal thread 34. The compensation element 3 is in threaded engagement with the base element 2 and can be moved by being rotated relative to the base element 2 from a starting position P1 into a compensating position P2, for example shown in FIGS. 11 and 12.

FIG. 3 schematically shows a sectional view of the device 1 according to FIG. 1.

The external thread 33 of the compensation element 3 has in particular a cross section that differs in shape from a circular cross section. Since the external thread 33 of the compensation element 3 has a cross section that differs in shape from a circular cross section, the compensation element 3 can be brought into a corresponding compensating position P2 by means of a screw member 5 (shown in FIG. 12) before the two components B1, B2 to be connected are fixed, in order to subsequently enable the screw member 5 to be tightened.

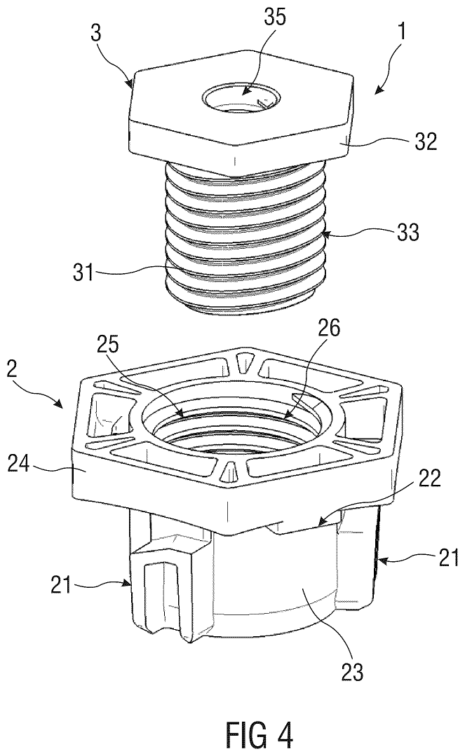

FIG. 4 schematically shows an exploded view of the device 1 according to FIG. 1.

The device 1 comprises at least one base element 2 having a cavity 26 having an internal thread 25, and a compensation element 3 having at least one external thread 33, which is or can be brought into threaded engagement with the base element 2 and can be moved from a starting position P1 into a compensating position P2 by being rotated relative to the base element 2, wherein at least the external thread 33 of the compensation element 3 has a cross section that differs in shape from a circular cross section and is in frictional engagement with the internal thread 25 of the base element 2 in the compensating position P2 in order to tighten a screw member 5.

The internal thread 25 of the base element 2 has in particular a circular cross section, wherein, in the compensation position P2, the compensation element 3 is in frictional clamping engagement with the base element 2 without any play. A clamping connection, in particular frictional engagement, without play can be achieved in a simple manner by the interaction of a circular or round internal thread 25 with a non-circular or non-round external thread 33.

FIG. 5 schematically shows a perspective view of the compensation element 3 of the device 1 (shown in FIG. 1).

The external thread 33 of the compensation element 3 has in particular a cross section that differs in shape from a circular cross section. Since the external thread 33 of the compensation element 3 has a cross section that differs in shape from a circular cross section, the compensation element 3 can be brought into a corresponding compensating position P2 by means of a screw member 5 (shown in FIG. 12) before the two components B1, B2 to be connected are fixed, in order to subsequently enable the screw member 5 to be tightened.

The external thread 33 of the compensation element 3 can have an oval cross section. The external thread 33 can have two rounded corners in cross section.

Alternatively, the external thread 33 may have an elliptical cross section. The external thread 33 can have two rounded corners in cross section.

Alternatively, the external thread 33 may have a trilobular cross section. The external thread 33 can have three round corners in cross section, also called a rounded triangle.

This makes it possible to achieve clamping, in particular self-locking, frictional engagement that has at least reduced play, in particular no play, when unscrewing the compensation element 3 from the base element 2. By means of such a contour and mating contour, in particular such an external thread 33 and internal thread 25, a particularly effective force fit and engagement can be made possible in a simple manner without additional means.

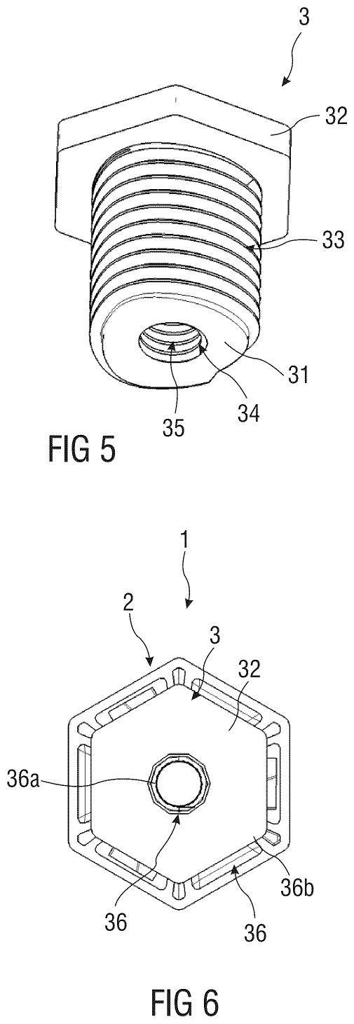

FIG. 6 is a schematic plan view of the device 1 according to FIG. 1.

The compensation element 3 comprises at least one drive contour 36, by means of which the compensation element 3 can be moved from the base element 2 into the compensating position P2 before the components B1, B2 to be connected are fixed. By rotating the compensation element 3 on the drive contour 36, for example in the form of a drive interface, the compensation element 3 can be moved relative to the base element 2, in particular out of the base element 2. As a result, a desired height H to be occupied (shown in FIGS. 11 and 12) of the device 1 can be set to overcome a predetermined distance between the components B1, B2.

The compensation element 3 can, for example, have an internal drive contour 36a. The compensation element 3 can, for example, alternatively or optionally additionally have an external drive contour 36b.

For example, the external drive contour 36b can be formed by the flange portion 32 of the compensation element 3, wherein the flange portion 32 can have an external circumference provided with corners and edges. The external drive contour 36b can be gripped by a suitable tool. The external drive contour 36b can be designed as a hexagonal drive or a square drive. A conventional drive tool, for example in the form of a wrench, can be used.

For example, the internal drive contour 36a can be formed by a recess or cutout formed in the center of the flange portion 32 of the compensation element 3, into which a suitable tool can be inserted. For example, the internal drive contour 36a can be designed as a hexagon socket or square socket, a slot or a crossed slot. A conventional drive tool (not shown in detail), for example in the form of a screwdriver, can be used.

FIG. 7 is a schematic perspective view showing the pre-positioning of the device 1 relative to one of the components B1, B2 to be connected (on a first component B1 in the illustrated embodiment).

Shown is the first component B1, which comprises the cutout B1.1 for the passage and arrangement of the base element 2. For example, the component B1 together with the cutout B1.1 forms a customer interface.

The device 1 is shown in a delivery state in which the compensation element 3 is in threaded engagement with the base element 2. The cutout B1.1 of the component B1 can have three guide grooves B1.2 corresponding to the retaining lugs 21 and to the positioning elements 22 of the base element 2.

The guide grooves B1.2 are designed in accordance with the distribution of the retaining lugs 21 and the positioning elements 22. For example, the guide grooves B1.2 are arranged rotationally symmetrically around the circumference of the cutout B1.1. The guide grooves B1.2 are each spaced apart and/or offset from one another within an angular range of 120°.

FIG. 8 shows a schematic perspective view showing the pre-assembly, in particular pre-fixing, of the device 1 on the first component B1 according to FIG. 7.

The base element 2 can have at least one drive contour 27, by means of which the base element 2 can be moved so as to assemble, in particular pre-assemble, and fix the device 1 on the first component B1. By rotating the base element 2 on the drive contour 27, for example in the form of a drive interface, the base element 2 can be moved together with the compensation element 3 arranged therein relative to the first component B1 and to the guide grooves B1.2.

The base element 2 can, for example, have an external drive contour 27a. The external drive contour 27a can be formed by the flange portion 24 of the base element 2, wherein the flange portion 24 can have an external circumference provided with corners and edges. The external drive contour 27a can be gripped by a suitable tool. The external drive contour 27a can be designed as a hexagonal drive or a square drive. A conventional drive tool, for example in the form of a wrench, can be used. Optionally, one can also rotate the compensation element 3.

The base element 2 is adjusted relative to the first component B1 until the positioning elements 22 of the base element 2 lock in the guide grooves B1.2, for example snap into the guide grooves B1.2. The positioning elements 22 can be reversibly flexible. The positioning elements 22 can therefore form an anti-rotation mechanism.

Due to the inclination of the respective support surfaces 211 of the retaining lugs 21, the flange portion 24, for example in the form of a shoulder, can be secured to the component B1 during rotation. This allows a bayonet lock to be achieved. The retaining lugs 21 are located below the interface, i.e. the first component B1, for example below the cutout B1.1.

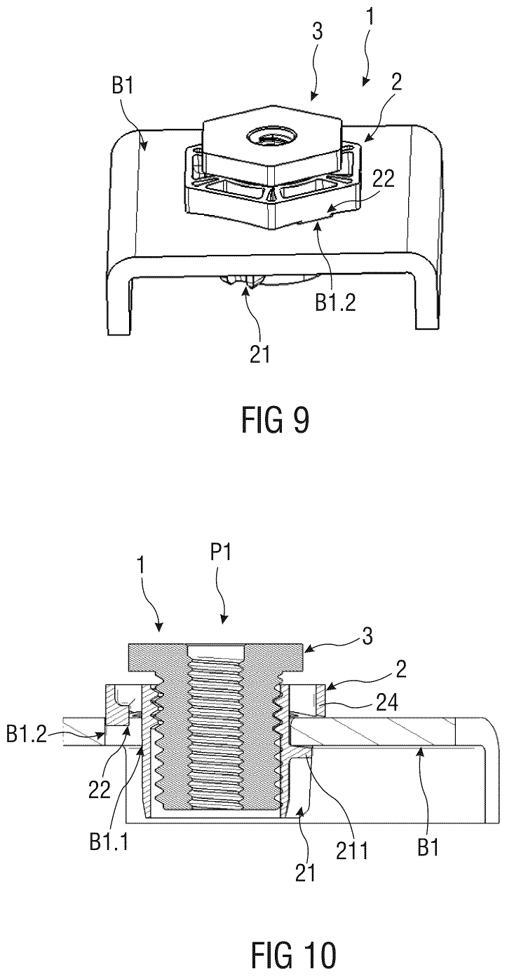

FIG. 9 is a schematic perspective view of the device 1 when assembled, in particular pre-assembled and fixed, on the component B1 according to FIG. 7.

The positioning elements 22 are designed, for example, in the form of flexible locking lugs, bulges, clip elements and/or raised portions. The positioning elements 22 are provided for radially positioning the base element 2 on the component B1 and preventing rotation in the interface, i.e. in the first component B1, for example in the cutout B1.1 of the component B1. The positioning elements 22 are provided for clamping, wedging and/or locking the base element 2 in and/or on one of the components B1, B2.

By means of the retaining lugs 21 and the positioning elements 22, the base element 2 is secured radially and axially in and/or on the associated component B1, B2. The device 1 and the first component B1 can be connected to one another in particular without any play.

FIG. 10 is a schematic sectional view of the device 1 when assembled, in particular pre-assembled and fixed, on the component B1 according to FIG. 9.

In the assembled state, the flange portion 24 rests against an upper side (or lower side) of the corresponding component B1, B2. In the assembled state, the first component B1 is arranged, and in particular secured, for example clamped and/or wedged, between the flange portion 24 and the retaining lugs 21, in particular their support surfaces 211. This allows axial tensile forces to be absorbed.

FIG. 11 is a schematic sectional view showing the adjustment of the compensation element 3 relative to the base element 2 and the component B1 of the device 1 from a starting position P1 into a compensating position P2.

By driving, in particular rotating, the compensation element 3 relative to the base element 2, the compensation element 3 can be adjusted to a desired height H to be occupied in order to overcome a predetermined distance between the two components B1, B2 to be connected to one another.

FIG. 12 is a schematic sectional view showing the fixation of a further, second component B2 to the device 1 and the first component B1.

If the compensation element 3 is at the desired height H relative to the base element 2, i.e. in the compensation position P2, the second component B2 can be fixed. In the compensation position P2, by means of its non-circular external thread 33, the compensation element 3 is in frictional engagement with the internal thread 25 of the base element 2 in order to tighten the screw member 4. The compensation element 3 is screwed to the second component B2. The screw member 4 can be tightened as a result of the frictional engagement between the compensation element 3 and the base element 2.

The screw member 4 can comprise at least a head 41, for example a screw head, and a shaft 42. The shaft 42 can be provided with a thread 43 at least in portions of the circumference. In the final assembled state, the head 41 of the connecting element 4 is supported on an upper side of the second component B2.

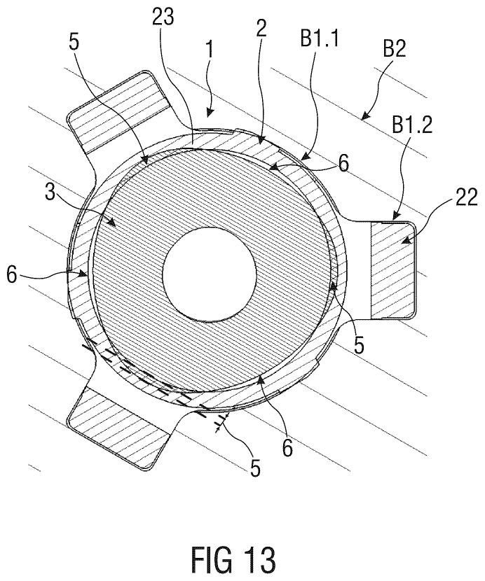

FIG. 13 is a schematic view from below of the device 1 when assembled, in particular pre-assembled, on one of the components B1, B2 to be connected.

The base body 23 of the base element 2 can be arranged in the cutout B1.1 of the component B1 without radial play. The positioning elements 22 can be arranged in the guide grooves B1.2 without play in the direction of rotation.

Due to the shape of the compensation element 3 that differs from a circular shape, zero play and a degree of torque can be provided with respect to the base element 2 by at least one resulting overhang 5 relative to the base element 2. The compensation element 3 can be clamped to the base element 2 in the corresponding region of the overhang 5.

At the same time, the compensation element 3 and the base element 2 can have a degree of play 6 relative to one another. For example, a circumference of the base element 2 can be larger than a circumference of the compensation element 3, for example measured at the flank diameter. This allows the base element 2 to assume a tribular shape of the compensation element 3, for example, without the circumference of the base element 2 having to be expanded. This can avoid plug-in stress.

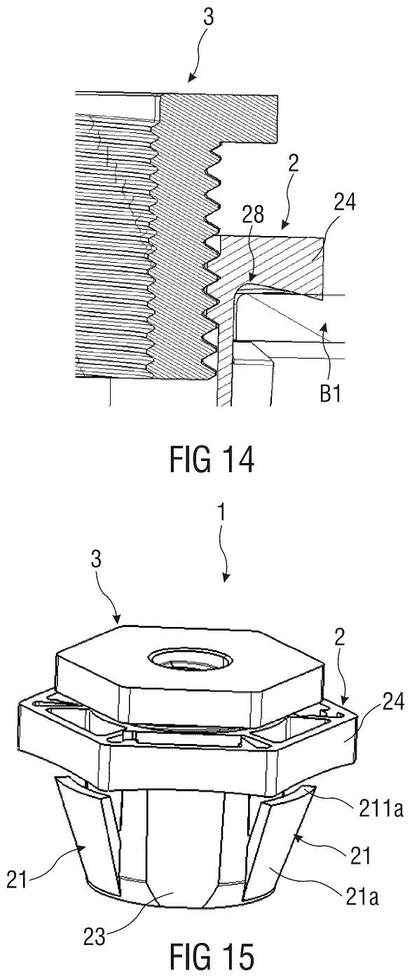

FIG. 14 is a schematic sectional view of a partial view of the device 1 when assembled, for example pre-assembled, on one of the components B1, B2 to be connected.

The base element 2 can be axially free of play with respect to the interface, i.e. to the corresponding component B1, B2. For this purpose, the flange portion 24, for example a collar or shoulder, of the base element 2 can be pressed over. By providing a concave profile 28 in the flange portion 24, the latter can be made elastic.

FIG. 15 is a schematic perspective view of a further embodiment of a device 1 according to the invention for compensating for tolerances between at least two components B1, B2 to be connected to one another, said device comprising at least one base element 2 having a cavity 26 having an internal thread 25, and a compensation element 3 having an external thread 33, which is or can be brought into threaded engagement with the base element 2 and can be moved from a starting position P1 into a compensating position P2 by rotating it relative to the base element 2.

In contrast to the previously presented embodiments, the base element 2 comprises retaining clips 21a as the retaining lugs 21. The retaining clips 21a can each have a support surface 211a extending in a straight line in the circumferential direction of the base element 2. The retaining clips 21a can each comprise a lower end connected to the base body 23 of the base element 2 and an upper end that protrudes from the base body 23 and forms the support surface 211a. When the base element 2 together with the compensation element 3 arranged therein is assembled, for example pre-assembled, on one of the components B1, B2, the component B1, B2 can be clampingly arranged between the flange portion 24, in particular the underside of the flange portion 24, and the corresponding retaining clip 21a.

When the base element 2 is assembled on one of the components B1, B2, the corresponding positioning element 22 can secure the base element 2 to prevent it from rotating.

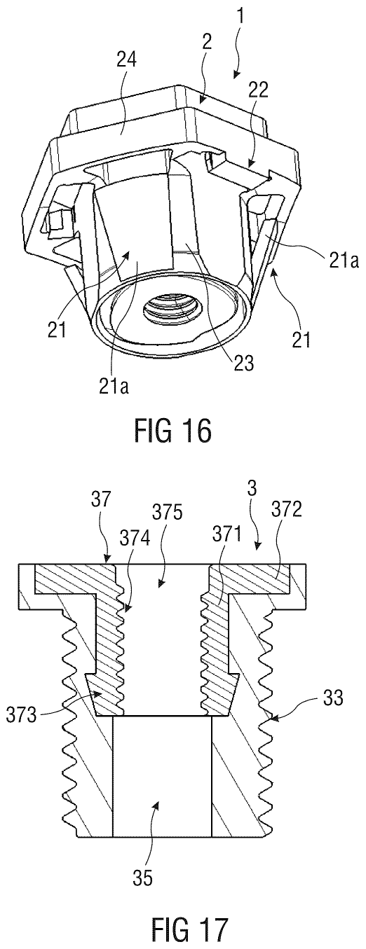

FIG. 16 schematically shows another perspective view of the device 1 according to FIG. 15.

Furthermore, the base element 2 comprises at least one positioning element 22 or a plurality of positioning elements 22.

In the illustrated embodiment, the base element 2 comprises three retaining clips 21a and three positioning elements 22. A positioning element 22 is arranged between each two retaining clips 21a, or a retaining clip 21a is arranged between each two positioning elements 22.

The retaining clips 21a are rotationally symmetrically distributed over the external circumference of the base element 2, in particular the base body 23. The retaining clips 21a are each spaced apart and/or offset from one another within an angular range of 120°.

The positioning elements 22 are rotationally symmetrically distributed over an underside of the flange portion 24 of the base element 2. The positioning elements 22 protrude downward from the underside of the flange portion 24. The positioning elements 22 are each spaced apart and/or offset from one another within an angular range of 120°.

The corresponding positioning element 22 is offset and/or spaced apart from the corresponding retaining clip 21a, for example by 60°.

FIG. 17 is a schematic sectional view of another embodiment of a compensation element 3 of a device 1 for compensating for tolerances between at least two components B1, B2 to be connected to one another.

The compensation element 3 comprises in particular an external thread 33, which has a cross section differing in shape from a circular cross section and, in the compensating position P2, is in frictional engagement with an internal thread 25 of the base element 2 in order to tighten a screw member 4.

The compensation element 3 can have a nut element 37, for example a metal insert, integrated in the cavity 35. By using a nut element 37, the compensation element 3 can be made from a simply non-reinforced material.

A base element 2 can be formed from a plastics material, for example. The base element 2 can be formed from plastics material containing glass fibers.

The compensation element 3 can be made of a plastics material, for example. The compensation element 3 can be made of PPA (polyphthalamide) or PA (polyamide), for example. The compensation element 3 can be made from a plastics material containing glass fibers.

The compensation element 3 and/or the base element 2 can also be made of metal, at least in portions.

The nut element 37 can, for example, be hollow cylindrical. The nut element 37 can have a base body 371 and a flange portion 372 arranged on the end face of the base body 371. At another end face of the nut element 37, the latter may comprise a fastening flange 373. The fastening flange 373 can be designed to fasten the nut element 37 in the cavity 35 of the compensation element 3. The nut element 37 may comprise a cavity 375 provided with an internal thread 374. In particular, the nut element 37 can have a shape corresponding to the compensation element 3.

The nut element 37 can be designed to come into threaded engagement with the screw member 4 in order to fix the two components B1, B2 to be connected when the screw member 4 is tightened.

### LIST OF REFERENCE SIGNS

1 Device
2 Base element
21 Retaining lug
211 Support surface
21a Retaining clip
211a Support surface
22 Positioning element
23 Base body
24 Flange portion
25 Internal thread
26 Cavity
27 Drive contour
27a External drive contour
28 Channel
3 Compensation element
31 Base body
32 Flange portion
33 External thread
34 Internal thread
35 Cavity
36 Drive contour
36a Internal drive contour
36b External drive contour
37 Nut element
371 Base body
372 Flange portion
373 Fastening flange
374 Internal thread
375 Cavity
4 Screw member
41 Head
42 Shaft
43 Thread
5 Overhang
6 Clearance
B1, B2 Component
B1.1 Recess
B1.2 Guide groove
H Height
P1 Starting position
P2 Compensating position

What is claimed is:

1. A device for compensating for tolerances between two components to be connected to one another, comprising:
a base element having a cavity having an internal thread, and
a compensation element having an external thread which is or can be brought into threaded engagement with the base element and which can be moved out of a starting position into a compensating position by being rotated relative to the base element,
wherein at least the external thread of the compensation element has a cross section differing in shape from a circular cross section and is in frictional engagement with the internal thread of the base element in the compensating position in order to tighten a screw member.

2. The device according to claim 1, wherein the compensation element has at least one drive contour, by means of which the compensation element can be moved from the base element into the compensating position before fixing the components to be connected.

3. The device according to claim 1, wherein the compensation element comprises a cavity having an internal thread, wherein, after assuming the compensating position, the screw member can be tightened in the cavity in order to fix the components to be connected.

4. The device according to claim 1, wherein the internal thread of the base element has a circular cross section, wherein, in the compensating position, the compensation element is in frictional clamping engagement with the base element, which engagement at least has reduced play.

5. The device according to claim 1, wherein the external thread has an oval, elliptical or trilobular cross section.

6. The device according to claim 1, wherein the external thread has at least two round corners in cross section.

7. The device according to claim 1, wherein the base element comprises a flange portion extending around at least portions of an external circumference and having at least one outwardly projecting retaining lug.

8. The device according to claim 7, wherein the retaining lug has a support surface which extends obliquely, at least in portions, in the circumferential direction.

9. The device according to either claim 7, wherein, when the base element is assembled on one of the components, the component can be or is clampingly received between the flange portion and the retaining lug.

10. The device according to claim 1, wherein the base element comprises at least one positioning element, which is designed to secure and/or lock the base element against rotating on the component when the base element is assembled on one of the components.
